(19) United States
(12) Patent Application Publication
(10) Pub. No.: US 2025/0131074 A1
(43) Pub. Date: Apr. 24, 2025

(54) SYSTEM AND METHOD FOR INTERFACE AND/OR DEVICE USER IDENTITY VERIFICATION

(71) Applicant: APP-POP-UP INC., Steinbach (CA)

(72) Inventors: Rajeev KUMAR, Disraeli (CA); Rakesh KUMAR, Disraeli (CA)

(21) Appl. No.: 18/383,248

(22) Filed: Oct. 24, 2023

(51) Int. Cl. G06F 21/32; G06F 3/0484; G06V 10/74; G06V 10/94; G06V 40/10

(52) U.S. Cl. CPC G06F 21/32; G06F 3/0484; G06V 10/761; G06V 10/945; G06V 40/10

(57) ABSTRACT

A system for interface and/or device user identity verification comprises a user device with a user interface and a camera, a system controller in communication with the user device and a databank. The databank comprises a stored image for each user as well as input command types associated therewith and requiring real time image identification. When a real time user command is inputted via the user interface and corresponds to a stored input command type, the stored image associated therewith is identified and a real time image of the real time user is captured via the camera. The system determines whether the captured image corresponds to the identified stored image. The real time input command is allowed to be executed if the captured image corresponds to the identified stored image and is prevented from being executed if the captured image does not correspond to the identified stored image.

### TECHNICAL FIELD

The present disclosure generally relates to computer user interfaces and user devices with associated cameras. More particularly, but not exclusively, the present disclosure relates to a system and method for interface and/or device user identity verification. Still more particularly but still not exclusively, the present disclosure relates to a security system and method for verifying the identity of a user when transacting and/or communicating via a user interface or when using a device such as a mobile device with a display screen for transacting and/or communicating via a user interface.

### BACKGROUND

User interfaces displayed via a mobile device provide users to transact with financial institutions, banks and merchants. Users are requested to enter a password or a one-time-password (OTP) and may be asked other security questions including date or birth, home address or other random questions to properly identify them. OTPs are sent via email or text for example as an additional security measure. Scammers have often obtained the passwords, emails, mobile device phone numbers and hence have been able to break into the accounts of users and may sell this information on the dark web or use this information. As such, imposters can use the credit cards or bank accounts or credit points of other users without their knowledge.

Verifying the identity of a user during user interface transactions/communications is important in protecting the security of users and their electronic financial and personal accounts.

### Objects

An object of the present disclosure, there is provided a system for interface and/or device user identity verification.

An object of the present disclosure, there is provided a method for interface and/or device user identity verification.

### SUMMARY

In accordance with an aspect of the present disclosure, there is provided a computer implementable system for interface and/or device user identity verification comprising: a user device comprising a device controller with an associated memory, a user interface, and a camera; a system controller in communication with the user device and comprising a processor with an associated memory of processor executable code; and a system accessible databank comprising a plurality of stored user profiles for each system user, each of the stored user profiles comprising a stored image of a respective one of the system users and one or more input command types associated with the stored image and requiring real time image identification, wherein execution of the processor executable code provides the computer implementable system with performing computer-implementable steps comprising: determining if a real time user command being inputted via the user interface corresponds to the one or more input command types requiring the real time image identification and identifying the stored image associated therewith thereby providing an identified stored image for user verification; capturing a real time image of the real time user via the camera when the real time user command corresponds to the one or more input command types requiring the real time image identification thereby providing a capture image; determining if the captured image corresponds or does not correspond to the identified stored image for user verification; allowing the real time input command to the be executed if the captured image corresponds to the identified stored image and preventing the real time input command from being executed if the captured image does not correspond to the identified stored image.

In an embodiment, the processor executable code is executed by the system controller and the computer-implementable steps are performed by the system controller.

In an embodiment, the processor executable code is downloaded in: the associated memory of the device controller to be executed by the device controller for performing the computer implementable steps or to be executed synergistically by a synergistic combination of the system controller and the device controller for the synergistic combination thereof to perform the computer implementable steps; and/or one or more third party memories associated with one or more third party controllers in selective operative communication with the system controller and/or the device controller to be executed by the one or more third party controllers for performing the computer implementable steps or to be executed synergistically by: a synergistic combination of the system controller and the one or more third party controllers for the synergistic combination thereof to perform the computer implementable steps; a synergistic combination of the one or more third party controllers and the device controllers for the synergistic combination thereof to perform the computer implementable steps; a synergistic combination of the system controller, the one or more third party controllers and the device controller for the synergistic combination thereof to perform the computer implementable steps. In an embodiment, the one or more third party controllers are selected from the group consisting of a financial institution controller, a merchant controller, and a combination thereof. In an embodiment, the step of determining if the captured image corresponds or does not correspond to the identified stored image for user verification is executed following a computer-generated request therefor by the system controller or by the one or more third party controllers of by the user device controller or by one any of the synergistic combinations thereof.

In an embodiment, the databank is stored in a computer memory selected from the group consisting of: the associated memory of the system controller; the associated memory of the user device; one or more third party memories associated with one or more third party controllers in selective operative communication with the system controller and/or the device controller; a synergistic combination of the associated memories of the system controller and the user device controller; a synergistic combination of the associated memories of the system controller and the one or more third party controllers; a synergistic combination of the associated memories of the user device and the one or more third party controllers; and a synergistic combination of the associated memories of the system controller, the user device controller and the one or more third party controllers.

In an embodiment, the one or more input command types are selected from the group consisting of a transaction request, an access request, communication request, a control request, a purchase request, a predetermined command request and any combination thereof. In an embodiment, the access request comprises accessing data selected from the group consisting of a file, a platform, a website, a databank, a memory bank, and a combination thereof. In an embodiment, accessing the file data comprises decrypting an encrypted file. In an embodiment, the purchase request comprises user payment information input.

In an embodiment, the one or more input commands are time and/or location dependent for execution thereof based on time and/or location parameters stored in the user profile. In an embodiment, the system further comprises the computer implementable steps of: controlling the camera to selectively capture images of an ambient environment thereby providing a plurality of captured environment images; retrieving the captured environment images; determining a geographic location of the device via accessing a geolocation tracking application.

In an embodiment, the one or more input command types comprise one or more user identifier inputs stored in the user profile for user verification. In an embodiment, the one or more identifier inputs are selected from the group consisting of: a passcode, a voice recognition input, a fingerprint recognition input, a touchscreen slide pattern input, user biometric data input, payment information, a device identification input, and a combination thereof. In an embodiment, device identification input is selected from the group consisting of a location identifier of the user device communicated thereby to the system, a subscriber identity module (SIM) identifier of the user device communicated thereby to the system, an internet protocol address (IPS) identifier of the user device communicated thereby to the system, an identifier code of the user device communicated thereby to the system and a combination thereof.

In an embodiment, the captured image is selected from the group consisting of a picture, a video, and a combination thereof.

In an embodiment, the stored image is selected from the group consisting of a picture, a video, and a combination thereof.

In an embodiment, the step of determining if the captured image corresponds to the identified stored image comprises determining a similarity between the captured image and the identified image above a predetermined threshold.

In an embodiment, the step of determining if the captured image corresponds to the identified stored image comprises determining a similarity between a portion of the captured image and a corresponding portion the identified image above a predetermined threshold.

In an embodiment, the stored image is captured via the camera following a user input command therefor via the user interface and prompted by a system request therefor via the user interface. In an embodiment, the stored image is captured via the camera following a given predetermined type of a real time user input command.

In an embodiment, when the execution of the real time input command is prevented from being executed, the system further comprises the computer implementable step of transmitting a signal indicative thereof. In an embodiment, the signal indicative of the prevented real time input command comprises a visual and/or audial and/or vibrational message transmitted via the user device. In an embodiment, the signal indicative of the prevented real time input command is blocks access to one or more online accounts associated with the user profile.

In accordance with an aspect of the present disclosure, there is provided a computer implementable method for interface and/or device user identity verification comprising: providing a databank comprising a plurality of stored user profiles for each system user, each of the stored user profiles comprising a stored image of a respective one of the system users and one or more input command types associated with the stored image and requiring real time image identification; determining if a real time user command being inputted via a user interface associated with a user device corresponds to the one or more input command types requiring the real time image identification and identifying the stored image associated therewith thereby providing an identified stored image for user verification; capturing a real time image of the real time user via a camera associated with the user device when the real time user command corresponds to the one or more input command types requiring the real time image identification thereby providing a capture image; determining if the captured image corresponds or does not correspond to the identified stored image for user verification; and allowing the real time input command to the be executed if the captured image corresponds to the identified stored image and preventing the real time input command from being executed if the captured image does not correspond to the identified stored image.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

The following drawings form part of the present specification and present disclosure. In the appended drawings:

FIG. 1 is a schematic representation of the system for interface and/or device user identity verification in accordance with a non-limiting illustrative embodiment of the present disclosure;

FIG. 2 is a schematic representation of user device of the system of FIG. 1 in accordance with in accordance with a non-limiting illustrative embodiment of the present disclosure;

FIG. 3 is a schematic representation of a user's image as captured by the system of FIG. 1 in accordance with a non-limiting illustrative embodiment of the present disclosure;

FIG. 4 is a schematic representation of user device of the system of FIG. 1 in accordance with in accordance with a non-limiting illustrative embodiment of the present disclosure;

FIG. 5 is a schematic representation of a system controller assembly of the system of FIG. 1 in accordance with in accordance with a non-limiting illustrative embodiment of the present disclosure; and

FIG. 6 is a schematic representation of a graphical user interface (GUI) of the system of FIG. 1 in accordance with in accordance with a non-limiting illustrative embodiment of the present disclosure.

### DETAILED DESCRIPTION OF ILLUSTRATIVE EMBODIMENTS

Generally stated, there is provided system for interface and/or device user identity verification comprises a user device with a user interface and a camera, a system controller in communication with the user device and a databank. The databank comprises a stored image for each user as well as input command types associated therewith and requiring real time image identification. When a real time user command is inputted via the user interface and corresponds to a stored input command type, the stored image associated therewith is identified and a real time image of the real time user is captured via the camera. The system determines whether the captured image corresponds to the identified stored image. The real time input command is allowed to be executed if the captured image corresponds to the identified stored image and is prevented from being executed if the captured image does not correspond to the identified stored image

In accordance with an embodiment of the present disclosure, there is provided a computer implementable system for interface and/or device user identity verification. The system comprises a user device a system controller and a system accessible databank. The device controller comprises an associated memory, a user interface, and a camera. The system controller is in communication with the user device and comprises a processor with an associated memory of processor executable code. The system accessible databank comprises a plurality of stored user profiles for each system user. Each of the stored user profiles comprises a stored image of a respective one of the system users and one or more input command types associated with the stored image and requiring real time image identification. Execution of the processor executable code provides the computer implementable system with performing computer-implementable steps. The system determines if a real time user command being inputted via the user interface corresponds to the one or more input command types requiring the real time image identification and identifies the stored image associated therewith thereby providing an identified stored image for user verification. A real time image a of the real time user is captured via the camera when the real time user command corresponds to the one or more input command types requiring the real time image identification thereby providing a capture image. The system determines if the captured image corresponds or does not correspond to the identified stored image for user verification. The real time input command is allowed to be executed if the captured image corresponds to the identified stored image and is prevented from being executed if the captured image does not correspond to the identified stored image.

In an embodiment, the processor executable code is executed by the system controller and the computer-implementable steps are performed by the system controller. In an embodiment, the processor executable code is downloaded in the associated memory of the device controller and/or one or more third party memories associated with one or more third party controllers in selective operative communication with the system controller. As such, the processor executable code ca be executed by the device controller for performing the computer implementable steps or is executed synergistically by a synergistic combination of the system controller and the device controller for the synergistic combination thereof to perform the computer implementable steps. In another example, the processor executable code is executed by the one or more third party controllers for performing the computer implementable steps or is executed synergistically by: (i) a synergistic combination of the system controller and the one or more third party controllers for the synergistic combination thereof to perform the computer implementable steps; (ii) a synergistic combination of the one or more third party controllers and the device controllers for the synergistic combination thereof to perform the computer implementable steps; (iii) a synergistic combination of the system controller, the one or more third party controllers and the device controller for the synergistic combination thereof to perform the computer implementable steps. In an embodiment, the one or more third party controllers are selected from the group consisting of a financial institution controller, a merchant controller, and a combination thereof. In an embodiment, the step of determining if the captured image corresponds or does not correspond to the identified stored image for user verification is executed following a computer-generated request therefor by the system controller or by the one or more third party controllers of by the user device controller or by one any of the synergistic combinations thereof.

In an embodiment, the databank is stored in a computer memory selected from the group consisting of: the associated memory of the system controller; the associated memory of the user device; one or more third party memories associated with one or more third party controllers in selective operative communication with the system controller and/or the device controller; a synergistic combination of the associated memories of the system controller and the user device controller; a synergistic combination of the associated memories of the system controller and the one or more third party controllers; a synergistic combination of the associated memories of the user device and the one or more third party controllers; and a synergistic combination of the associated memories of the system controller, the user device controller and the one or more third party controllers.

Input command types include and without limitation thereto: transaction request, an access request, a communication request, a control request, a purchase request, a predetermined command request and any combination thereof. In an example, an access request comprises accessing data such as and without limitation thereto a file, a platform, a website, a databank, a memory bank, and a combination thereof. Accessing the file data includes decrypting an encrypted file. A purchase request may include user payment information input.

The one or more input commands may be time and/or location dependent for execution thereof based on time and/or location parameters stored in the user profile. Thus, the system controls the camera to selectively capturing images of an ambient environment thereby providing a plurality of captured environment images and retrieves the captured environment images to determine a geographic location of the device via accessing a geolocation tracking application.

The one or more input command types can include one or more user identifier inputs stored in the user profile for user verification. Non-limiting examples of user identifier input include without limitation a passcode, a voice recognition input, a fingerprint recognition input, a touchscreen slide pattern input, user biometric data input, payment information, a device identification input, and a combination thereof. Examples of device identification inputs include and without limitation thereto, a location identifier of the user device communicated thereby to the system, a subscriber identity module (SIM) identifier of the user device communicated thereby to the system, an internet protocol address (IPS) identifier of the user device communicated thereby to the system, an identifier code of the user device communicated thereby to the system and a combination thereof.

The captured and stored images can be pictures, videos and the like or combinations thereof.

In an embodiment, the step of determining if the captured image corresponds to the identified stored image comprises determining a similarity between the captured image and the identified image above a predetermined threshold. In an embodiment, the step of determining if the captured image corresponds to the identified stored image comprises determining a similarity between a portion of the captured image and a corresponding portion the identified image above a predetermined threshold.

In an embodiment, the stored image is captured via the camera following a user input command therefor via the user interface and prompted by a system request therefor via the user interface. In an embodiment, the stored image is captured via the camera following a given predetermined type of a real time user input command.

In an embodiment, when the execution of the real time input command is prevented from being executed, the system further comprises the computer implementable step of transmitting a signal indicative thereof. In an embodiment, the signal indicative of the prevented real time input command comprises a visual and/or audial and/or vibrational message transmitted via the user device. In an embodiment, the signal indicative of the prevented real time input command is blocks access to one or more online accounts associated with the user profile.

In an embodiment, the user interface includes an input/output interface. In an embodiment, the user interface includes a display interface including a screen for displaying a graphical user interface.

Non-limiting illustrative embodiments of the disclosure will now be further described with reference to the Figures so as to further exemplify the disclosure and by no means limit the scope thereof. In an embodiment, the user interface comprises a keypad, and/or a microphone, and/or a speaker, and/or a sensor, and/or a camera and/or a vibration imparting device and the like as is known in the art.

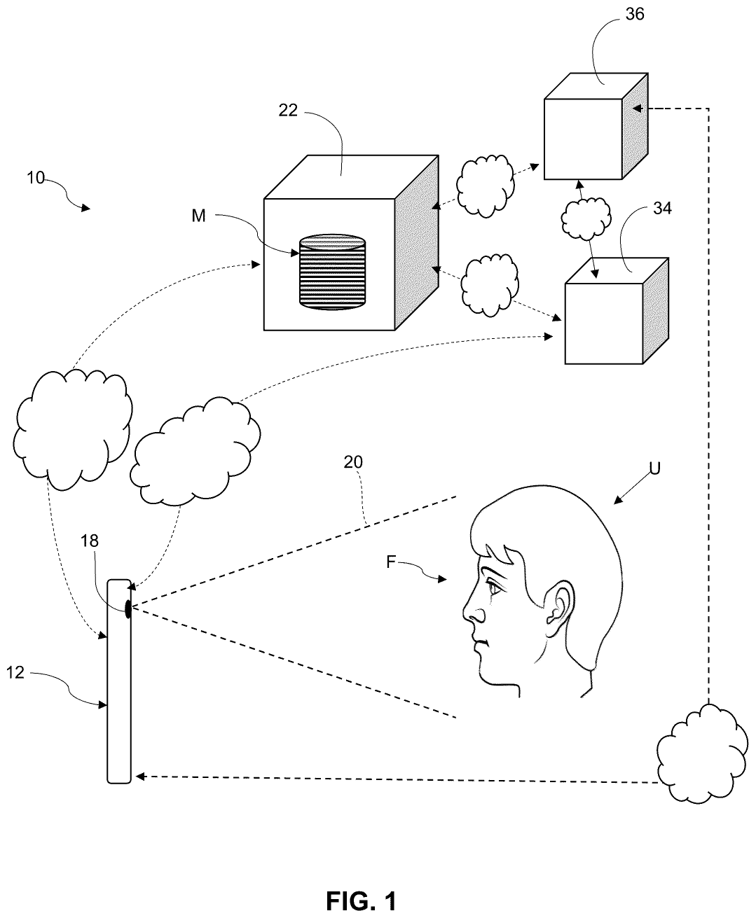

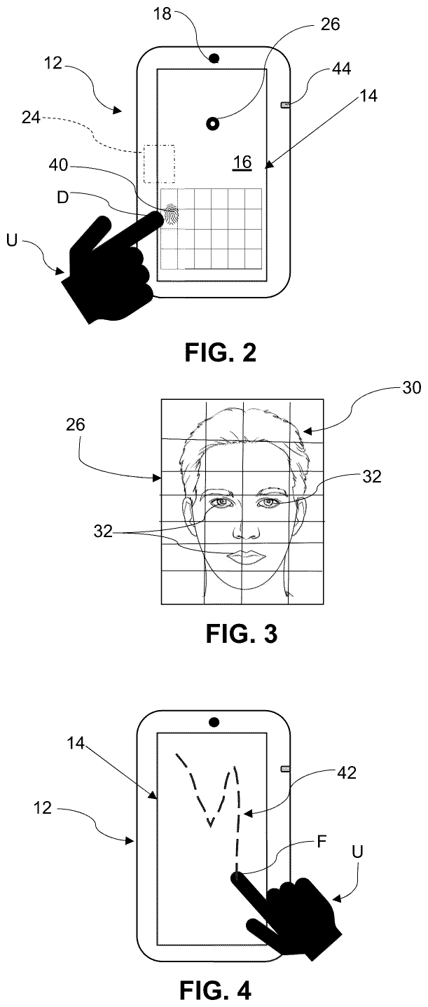

FIGS. 1 and 2 show a system 10 for verifying the identity of an interface user U. The system 10 includes a user device 12 having a user interface including a display screen 14 for displaying an graphical user interface 16 as well as a camera 18. The user device 12 can be a selected from a variety of devices such as for example and without limitation to a mobile device (smartphones, smartwatches etc.), a tablet, a PC, a TV, a mounted computer used for gates or in factories, a vehicle computer, VR/AR/XR glasses providing virtual screens and the like as can contemplated within by the person having skill in the art. The camera 18 of the user device 12 captures images within its field of view (FOV) 20 thereby providing for capturing images of the user U looking at the screen 14 within the FOV 20. The images (e.g., contiguous, or intermittent video, still shots, time stamps etc.) captured by the user device 12 via the camera 18 are transmitted to a system controller 22 for analysis.

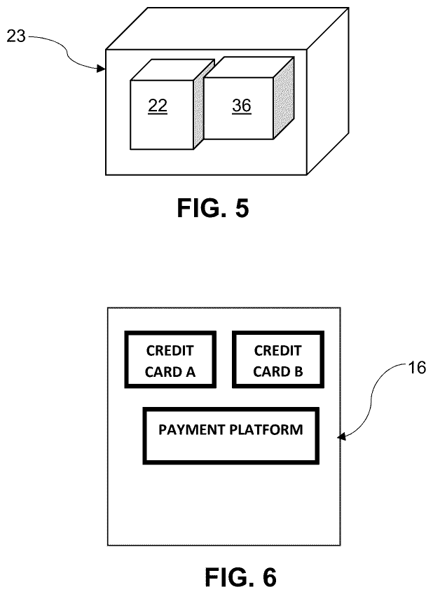

The system controller 22 has a memory M (including a databank) of predetermined parameters and user profiles. The system controller 22 is in operative communication with the user device 12 and has a processor with an associated memory M of processor executable code for being executed by the system controller 22 or for being downloaded into the memory of the user device controller 24 (see FIG. 2) to be executed thereby or to be executed synergistically by a combination of the system controller 22 and the device controller 26. In an embodiment, the system controller 23 (see FIG. 5) comprises an assembly of associated controllers in operative communication therewith via a cloud network and the like. Thus, the memory M herein can be stored anywhere within this computer architecture as can be contemplated by the skilled artisan. Indeed, the system controller 22 can comprises a server or a plurality of servers. The term “controller” herein is not used to designate only a a single server but also and without limitation to a cloud based computer architecture as is known and understood in the art. Execution of the processor executable code by the system controller 22 or by the device controller or by the synergistic combination thereof provides for the system controller 22 or the device controller or the combination thereof with performing computer-implementable steps as disclosed herein.

The system controller 22 executes the computer implementable steps of analyzing the images and comparing them to the pre-stored images within the memory M. For example, a user U via a system interface 16 displayed via the display screen 14 is provided with storing a user profile within the memory M. In one example, the system controller 22 executes the computer implementable step of providing the user U to create a user profile by responding to a variety of identity questions which are saved within the memory M. In order for the profile registration to be completed, the user must upload an image of themselves.

In an embodiment and with reference to FIGS. 1 and 3, the system controller 22 during user profile creation executes the computer implementable step of accessing the device controller 24 to control the camera 18 to takes an image of the user's face F. In an embodiment, the user U controls the camera 18 via their device 12 and takes the image themselves. In an embodiment, the system controller 22 requests via the interface 16 from the user U to look towards the screen 14 at a controller created icon 26 on the interface 16 in order to calibrate the position of the user's face and thus capture a system acceptable image of the user U.

As shown in FIG. 3, the system controller 22 captures an image 26 and saves it in the user profile within memory M.

In an embodiment, the system controller 22 creates a cartesian grid 30 of this image 28 or otherwise partitions the image into portions 32 in order to compare the grid 30 and and/or image portions 32 to a subsequent image (including grid and/or portions) as will be further discussed below.

In an embodiment, the device 12 via camera 18 is provided to simply capture an image (i.e., picture, short video) and transmit the picture to the system controller 22 without any calibration, grid, cartesian table or further analysis as described herein. The captured image 28 is transmitted in real time to the system controller 22 alone or together in real time with passwords, OTPs and the like, in sequence or simultaneously, entered by the user to input a command.

In U.S. application Ser. Nos. 17/443,563 and 18/071,751, which are incorporated herein by reference in their entirety, systems for modulating user input image commands and/or positions on a graphical user interface (GUI) based on a user GUI viewing are taught. These systems monitor the position of the eyes and irises relative to the GUI for user modulation. As such, in an embodiment, the user profile includes image portions 30 of the eyes and irises of the user U. As will be further discussed, captured images of the eyes and irises and/or other portions 30 of the face F are compared to stored images 28 and stored portions 30.

Thus, the images 28 and/or portions 32 thereof are saved in the user profile and when the user wishes to transact via an interface with the system controller 22 and/or more other controllers 34 (see FIG. 1) in operative communication with the controller 22 and/or the device controller 24, the images 28 and/or portions 30 are compared with real time captured images of the current real time user.

For example, when a given real time user browses a commercial online platform and selects an item for purchase, the user is effectively transacting/communicating with a merchant sever 34. In one scenario, the user has to upload their credit card information in order to make a purchase. Prior to allowing their credit card information to be entered onto the merchant platform, the system controller 22 being in operative communication with the device 12 monitors the communication between the device controller 24 and the merchant controller 34 and executes the real time computer implementable step of identifying a credit card entry. When the system controller 22 identifies that the required credit card information has been entered, it controls the camera 18 to take one or more real time images of the user. In one embodiment, the system identifies that the transaction is being processed when the user clicks on a transaction processing command.

The real time image or images are transmitted to the controller 22 to be compared to the profile registered image in the memory M. If it is determined that the real time captured image or images are the same as the registered images, the identity of the user is thus confirmed, and the transaction proceeds normally. If it is determined that the real time captured image or images do not match the registered image, then the transaction is blocked as the identity of the user has not been confirmed.

The transaction may be blocked in a variety of ways. In one example, the system controller 22 communicates with the financial institution controller 36 that has issued the credit card with the payment controller 36 responsible for approving the transaction to block the credit card from being accepted.

In another embodiment, the payment or financial institution controller 36 requests a confirmation from the system controller 22 regarding the real time identity of the user. For example, once the user has clicked to make a payment on the transaction platform, the payment/financial controller 36 receives a command to accept the transaction, the controller 36 sends a signal to the system controller 22 to approve the identity of the real time user, once the controller 22 receives this signal it then captures the real time image for comparison as provided herein and signals back to the controller 36 whether or not the identity of the real time user is confirmed and contingent upon this confirmation, the controller 36 accepts or refuses the transaction. As such, the controller 22 may either monitor the online transaction directly and signal the payment controller 36 regarding real time user identity confirmation or may receive this request for real time user identity from the payment controller 36.

In another embodiment, the system controller 22 sends a signal to the merchant controller 34 to proceed or not to proceed with the payment transaction based on real time user identity confirmation. In a further embodiment, it is the payment controller 36 that sends the foregoing signal (after receipt thereof from the system controller 22) to the merchant controller 34 to proceed or not to proceed with the payment transaction based on real time user identity confirmation. In yet another embodiment, the merchant controller 34 sends a request to the system controller 22 and/or payment controller 36 to confirm the identity of the real time user prior to accepting the transaction.

In an embodiment and as shown in FIG. 5, the system controller 22 and the payment controller 36 can be one and the same or form part of the same controller assembly 23. As such, the terms “system controller” and “controller assembly” as used herein are interchangeable in certain embodiments and implementations as can be understood by those having skill in the art.

In an embodiment, the user profile includes one or more payment method accounts such as credit cards and the like. As such, a user has their various payment method accounts already registered in their profile. Accordingly, when the user is shopping online and selects an item for purchase as previously explained, they can select one or more of the various payment methods as represented in FIG. 6. Once they click on a given payment method, the transaction automatically proceeds without having to enter additional information such as credit card information as the foregoing has already been uploaded into the user profile. Accordingly, the system 10 verifies the identity of the user in order to allow the transaction to proceed or to block it as described above.

A such, if the system controller 22 or assembly controller 23 determines that the identity of the real time user is not the same as the registered identity, the transaction is not processed. This can be done by system controller assembly analysis or a system controller 23 communicating its non-confirmed identity signal to the payment controller 36 and/or the merchant controller 34 or via requests from either of the foregoing as previously explained.

The present system is not only applicable to commercial transactions but to input commands in general. Any input command that selectively requires additional security can be either allowed to proceed or blocked as provided for the non-limiting commercial transaction examples described above. For example, in systems in which eye orientation is required such as U.S. Ser. No. 17/443,563 and U.S. Ser. No. 18/071,751, the system 10 can also further analyze the eyes and the irises. Indeed, only the portions 32 (e.g., portions of the facial image 28 corresponding to the eyes and/or irises) can be analyzed by the system 10 as explained above or both the facial image 28 in addition to the portions 32 Moreover, the system controller 22 (or 23) can also use artificial intelligences and/or machine learning applications to increase its analytical capabilities. Indeed, the system controller 22 (or 23) can use a variety of convenient facial recognition technologies within the scope of the present disclosure. Therefore, users trying to input commands via their eye orientation when looking at an interface as taught in the incorporated art can be blocked if they are not the authorized user.

In an embodiment, the camera 18 is controlled via AI and ML applications executed by the system 10 for capturing images at a convenient time. Indeed, the initial stored images can be captured automatically when a user inputs a command type such as registering on a platform.

In an embodiment, the camera 18 is controlled to take a series of images including pictures and/or videos and compare these images with the registered images in the user profile. In an embodiment, the system controller 22 determines a probability of similarity that is over a predetermined threshold in order to provide a confirmation of identity.

In an embodiment, when the system 10 determines that the real time user is not the authorized user, the real time captured images are sent to the authorities and/or the financial institution that issued the payment credentials of the user, and/or the merchant that the real time user is attempting to transact with. The foregoing information may be sent via email or by communication accounts set up to receive such information via controller (server) intercommunication as can be understood by those having skill in the art.

If at any time, there is a failure to input a command such as a transaction due to non-confirmed identity as provided herein, a message is sent by the system controller 22 to the same or another user device in order to provide the user with the opportunity of disabling the device 12, the account or platform being used to transact, the passcodes etc. thereby allowing the user to take the necessary actions to protect their online accounts, passcodes, computer devices etc.

In an embodiment, when the user is determined not to be authorized i.e. the real time captured image did not correspond to the registered image, the system controller 22 via the device controller 24 causes the device controller to signal an alarm including an audial, a visual and/or a vibrational alarm and combinations thereof. In another embodiment, the system controller 22 via the device controller 24 blocks the device 12 from being used. For example, the device 12 is locked and the screen 14 and interfaces 16 are not responsive etc.

Many web based platforms require passwords or OTPs to be accessed. The system 10 provides for an additional user identity confirmation along with other more conventional security measures. Thus, a payment controller 34 will not authorize payment if both the OTP confirmation along with the identity confirmation provided herein have not been signaled thereto as provided herein.

In an embodiment, along with the image of the user, the user has registered additional identifier data in their profile which are compared to real time identifier data captured during device 12 usage to determine if the real time captured identifier data matches or is similar (over a predetermined threshold of probability) to the registered additional identifier data so as to determine that the real time user is the registered user or not.

The additional identifier data is selected from the group consisting of user personal and/or physical identifier data, device identifier data, time of interface communication related identifier data and combinations thereof. As such, the system 10 provides for selectively allowing or selectively blocking an input command including a transaction based on a combination of image identification and an additional identifier confirmation with or without a conventional security step such as password or OTP and the like.

In an embodiment, the physical identifier data is selected from the group consisting of voice identification/recognition, fingerprint identification/recognition, touch screen input command pattern identification/recognition, biometric identifiers and the like and combinations thereof. Thus, these physical identifiers are captured by the device 12 and transmitted to the controller 22 to be registered within the user profile for comparison with real time captured physical identifiers.

In an embodiment, the device identifier data is selected from the group consisting of a SIM card identification, telephone number identification, IP address identifiers, location of device identifies including time-dependent location identifier, service provider identifiers and the like and combinations thereof.

In an embodiment, time of interface communications identifiers comprises without limitation the time of day and/or the day or days of the month and/or the period of the year that the user input certain command types. Indeed, the time-dependent command types may also be further location dependent. Therefore, the system controller 22 has a set of parameters in its memory in which certain input commands for certain types of interface communications (commercial, legal, personal etc.) are time and/or location dependent. In other words, a user does not access their business account during the summer after midnight when they are in the Caribbean. Another example is that a user only purchases certain items in the morning during the weekend. A further example is that a user does not use certain input commands for certain specific platforms between 1 am and 5 am on weekdays. Of course, a variety of combinations regarding time (time, day, month, period of year), location and input command type can be contemplated, and parameters therefor can be programmed and set in the memory M of the controller 22. These parameter combinations are registered in the user profile.

In order to determine the location of the user device 12, the system controller 22 accesses the GPS application of the device 12 via the device controller 26.

Turning to FIG. 2, a user U enters a security code by tapping their finger D on the touch screen 14 which includes a keypad input command image 38 (i.e., virtual keyboard) on a graphical user interface (GUI) 16 which is provided by the system controller 20 to capture fingerprint 40 images. In an embodiment, the touch screen 14 comprises a sensor that takes an image of the fingerprint 40 or small sections/portions thereof. The captured fingerprint 40 images or image portions thereof are sent to the controller 22 for analysis. As such, the controller 22 includes a registered user fingerprint and the real time captured images of the real time user fingerprint are compared to the fingerprint images registered in the user profile of the controller memory M to determine if the real time images correspond to the registered image of the fingerprint. A keypad input command image 38 is configured to capture and/or recognize fingerprint 40 of the user and as such acts as a fingerprint user interface as is understood in the art.

In an embodiment, the physical identifier comprises the pattern with which the user taps on the screen 14 with their finger D when entering their PIN, password, OTP etc. This pattern is registered when the profile is being created and the real time captured pattern is compared to the registered pattern to determine if there is a match or a probability of similarity above a pre-determined threshold in order to provide a physical identifier confirmation.

In an embodiment and as shown in FIG. 4, the passcode is a slide pattern 42 performed by the user's finger D on the touch screen 14. In an embodiment, confirmation of the user identity requires image recognition, passcode identification and fingerprint recognition.

In an embodiment, the user registers their SIM card 44 (see FIG. 2) serial number in their user profile in the memory M of the system controller 22. In an embodiment, a SIM card is not activated until it has been registered in the user profile. In an embodiment, a SIM card provider controller 34 and the system controller 22 form a same controller assembly such as assembly 23. Therefore, a user may need to register their SIM card serial number on the system controller 22, the SIM card provider controller 34 of the assembly 23. In an embodiment, the SIM card is only activated once it is registered and a user photo is registered as provided herein. Therefore, the user profile includes the image of the user and their SIM card number.

Of course, the system controller 22 can also be a merchant controller 34 (including and without limitation, a communications provider) and/or a payment controller 36 (i.e., payment system provider, credit card provider, financial institution, bank and the like).

Therefore, when a user communicates with their device 12, an input command is allowed to be processed if both the facial identity of the user and their registered SIM card number are confirmed.

As such, when a user transacts with a payment controller 36 and/or a merchant controller 34, the camera 18 takes images of the real time user and the system controller 22 communicates with the device controller 24 to read the SIM card being used and compare it with the user profile registered SIM card in the memory M. The transaction is not processed until there is both confirmation of their facial identity and their SIM card.

If a SIM card is stolen, the user who owns the stolen SIM card can access an online platform provided by the system controller 22 and following identification including image confirmation as provided herein the user can request via input commands to the system controller 22 that their SIM card be blocked.

If a thief has obtained the stolen SIM card and attempts to communicate using the SIM card, the system controller 22 detects the use of the SIM card and thereby communicates with the device of the thief to determine the GPS location, attempt to take an image by accessing the camera of the thief's device and/or signal an alarm to the thief. The data collected (location, image etc.) is selectively transmitted to the concerned authorities, merchants, payment providers and client users. In an embodiment, once the system controller 22 determines that a stolen SIM card is being used it sends a GUI request to the thief via their device if they wish for the communication request to go through. For example, the thief makes a call, the system controller 22 sends a message displayed via the display screen if they wish to continue with the call, once the thief accepts, an application is downloaded onto the thief's device to allow the system controller to access the device's GPS location, IP address, phone serial number, camera etc. in order to identify the thief and their location.

In an embodiment, when a SIM card is disabled it means that no call can be made as the mobile network operators use a SIM card's IMSI (International Mobile Subscriber Identity) and ICCID (Integrated Circuit Card Identifier) information to verify the holding user and decide whether to grant network access to the associated device. The system controller 22 has communicated that the mobile network operators that the given SIM card should not be granted network access and the mobile networks operators are requested to instead divert access to the system controller 22 which communicates directly with the device using the SIM card and as such, the controller 22 communicates directly with the device carrying the SIM card in order to access its device controller and identify the location of the SIM card, capture images of the unauthorized user and signal an alarm.

Of course, other device identifiers instead of or in addition to the SIM card can be registered in the user profile such as a device chip, an eSim, device serial number, an IP address and the like. In one example, if a user reports via the system controller 22 as provided herein that their smartphone device is stolen or missing and the system controller 22 detects, after such an update usage, of the reported smartphone device via operative communication therewith, the system controller 22 accesses the camera 18 to take images and sounds of environment of the reported smartphone, detects its GPS location, signals an alarm, disables all applications, and reports the foregoing to the concerned parties (authorities, merchants, payment providers, clients etc.) as provided herein.

Identification input commands as provided herein can be executed successively with or without a predetermined order or simultaneously (i.e. image capture and voice command).

In an embodiment, input commands via given platforms (merchants, payment providers) are only allowed via a given device 12. Thus, a user registers their smartphone device into their user profile and requests that payment transactions are only executed via this particular smartphone device 12. Hence, the system controller, in order to allow or block the input command from being processed (i.e. commercial transaction or other request), the input command has to be entered via the registered device only.

Other additional physical or personal identifiers are codes, voice recognition and tapping codes. For example, in one embodiment, the user must tap their touch screen three times and provide a password via voice command in addition to the image recognition.

Indeed, various combinations of the above identifiers to increase user security and privacy can be contemplated within the scope of the present disclosure.

In an embodiment, the input command that is allowed to be processed or blocked from being processed is decryption of encrypted data. For example, a user's personal or commercial data is saved on their device 12 or their cloud account in encrypted format. The data is decrypted to be accessible only after image recognition and alternatively additional identifier confirmation. Thus the system controller 22 executes the computer implementable step of allowing an input command from the user via a device 12 to decrypt data following identity confirmation as provided herein. In another embodiment, all the data of the GUI 16 is encrypted making a device 12 impossible to use without user identification as provided herein.

In an embodiment, the foregoing decryption is executed in real time once the user U accesses an interface 16 to input commands, the system controller 22 via the camera 18 confirms their identity and provides all information on interface 16 displayed via display screen 14 in readable form automatically. If a thief obtains the user's device, the GUI 16 displayed via the display screen 14 and all applications and information displayed will appear in encrypted non-readable format. The thief tapping or clicking on the device 12 to open an application, file or otherwise input a command via an input interface (keyboard, mouse, keypad etc.) or voice command would signal input command for decryption, the system 10 would verify the identity of the user in real time and determine that the real time user is not the register user and thus would not allow decryption. If the actual register user would be using the device then the system 10 would determine that the real time user is the registered user and decryption would proceed as it is being requested by input commands (tapping, clicking, pressing etc.) that indicate use of the interface 16.

Indeed, a hacker would be faced with the same challenge as accessing an account would require image recognition confirmation and other identifiers as provided herein to decrypt data.

In an embodiment, the system controller 22 intercepts all payment receipts, confirmation codes, message, images, information, transaction numbers and details communicated by a merchant controller 34 and/or a payment controller 36 with respect to a user transaction and automatically encrypts this data for decryption by the user as provided herein.

In an embodiment, all documents/files saved in the device 12 memory (associated with the controller 24) are automatically encrypted by the system controller 22 for decryption by the user as provided herein. In an embodiment, the documents/files comprise images, in an embodiment, the images comprise photos.

In an embodiment, the system controller 22 provides the device 12 with an application so that the device controller 24 executes the automatic encryption as provided herein.

In an embodiment, merchant controllers 34 and/or payment controllers 36 are provided with a software development kit (SDK) by the system controller 22 to execute the computer implementable steps for user identification as provided herein.

In an embodiment, the system controller 22 and the merchant controller 34 are one controller or one controller architecture (including a controller assembly). In an embodiment, the system controller 22 and the payment controller 36 are one controller or one controller architecture (including a controller assembly). In an embodiment, the system controller 22, the merchant controller 34, and the payment controller 36 are one controller or one controller architecture (including a controller assembly). In an embodiment, the merchant controller 34 and/or the payment controller 36 respective comprise a computer architecture of one or more controllers in operative networked communication. In an embodiment, the merchant controller 34 and/or the payment controller 36 are third party controllers relative to the system controller. In an embodiment, the system 10 comprises more than one merchant controller and/or more than one payment controller. Thus, the singular use of the term “controller” may include the plural “controllers” in certain implementations as can be readily understood by those having skill in the art.

Indeed, the system 10 comprise a system controller 22 for being operative communication with computing network architecture comprising one or more additional system controllers or third party controllers for the various cloud configurations provided herein.

A variety of permutations of the verification steps can be contemplated within the scope of the present disclosure. Image capture and verification along with another conventional or additional verification measure or additional user identity confirmation step as disclosed herein including the additional identifier data selected from the group consisting of user personal and/or physical identifier data, device identifier data, time of interface communication related identifier data and combinations thereof can be required to complete verification and confirmation. One, two, three, or more of these verification steps may be required and they may be executed simultaneously, concurrently, in sequence, in real time, automatically and/or with user input commands. The skilled artisan can thus contemplate a variety of permutations of the foregoing which are within the scope of the disclosure.

Verification may be accomplished by the system controller 22 and/or device controller 24 and/or by the synergistic combination/cooperation thereof separately from or in partial or full synergistic cooperation with one or more third party controllers including merchant an/or payment controllers, where one or more third party controller executes one or more of the verification steps and the system controller 22, device controller 24 and/or combination thereof execute another one or more of the same or other ones of the verification steps. Indeed, the present disclosure provides for a computer implementable method of the computer implementable steps disclosed herein and is not limited to a certain controller performing certain steps but only the presence of controller or controllers capable of performing the computer implementable steps in various permutations that are within the skill of the art to design for convenience and security.

In an example of the disclosure, system 10 provides for the device 12 to automatically capture an image 28 of a user U. The image 28 is of the face F (including the eyes), once the image is captured then the user can input a command via the interface 16 or execute an additional verification. In this case, there are two separate and consecutive identity verification steps. In another example, the two verification steps (image capture) and other (passcode etc.) are done simultaneously. In some cases, and since turning the camera on usage battery power, the camera 18 of the device 12 is off and the computer implementable steps herein provided it to turn it on to capture an image 28 (picture, video) once an input command has been detected by the system 10 (i.e. by the controller 22, 23, 24 or synergistic combinations thereof). The input command includes a passcode or the like. Once the passcode is entered, the camera 18 is activated to capture an image 28 for processing and then disactivated thereby reducing battery load.

In an embodiment, when the system 10 executes the two step image capture and passcode verification and this information is transmitted to a third party server such as a bank server 36 to process simultaneously and automatically or in-line/busbar or in any convenient sequence. The server 36 may request an additional input command for verification via the interface 16. In an embodiment, the system controller 22 or device controller 24 (or synergistic combination thereof) matches the user's face/eyes, etc. with the stored user profile images and then allows the password and/or passcode, OTP etc. to be sent to the bank server 36. In another embodiment, both the image and the passcode are transmitted to the third party server simultaneously and in real time.

In another example, when user opens a checkout or pay now icon online or fills out their bank details including their credit card or debit card information on a platform, then the system controller 22 and/or the device controller 24 opens the device camera 18 and takes a real time picture of the user and sends it to controller 22 or platform server (34, 36) along with the password the user is entering in real time and automatically.

In an embodiment, in order to process any input command through the device 12 on a platform, or on the device 12 or on the system controller 22 the two verification step is required.

In another example, a triple verification step can be required. In an example, the first two verification steps are an image capture and a fingerprint verification and these are executed simultaneously and automatically in real time as the user engages the touch screen 14 to execute an input command via the interface 16, the image of the user is captured via the camera 18 and the fingerprint is captured via the touch screen 14. The third verification step requires identifying the device 12 such as the phone number registered on the device, the SIM card, the eSim etc. and this data is forwarded to be processed as provided herein by the controllers 22, 23, 34 and 36 as previously discussed.

In one example, and as previously discussed, the system 10 determines that an input command is not being executed via a user's device then this input command is not processed.

The following are additional real world use cases of the present system and method to further exemplify the disclosure and by no means limit the scope thereof.

In an embodiment, when using an ATM device 12 the, user U inserts their debit card or credit card in the slot and enters their password using the keypad (user input/output interface) or the virtual keypad in the GUI 16 displayed by the screen 12. The ATM device comprises a camera 18 that captures an image 28 (picture or short video) of the user. In order for the input command to be processed and for the user U to access their account, both a password and photo is required. In an embodiment, the ATM controller 26 or the bank server 36 does not have a stored memory of a user photo. In this example, the captured image is simply kept on record and accessible via their bank platform. If there is an issue, then the user can make a complaint and show the captured image and time stamp and transaction to have it annulled. In another embodiment, the image is sent to a user's email account or via a text message or via another social media platform, pre-registered in their user profile. In another embodiment, the captured image is displayed via the interface 16 and shown to the real time user. The interface 16 requests once the picture is shown for the real time user to continue or not with the transaction by clicking on a continue command image icon for example or a not continue command icon for example. If the real time user decides not to continue once they see their picture, there is a strong likelihood that they are not the authorized user. If the real time user refuses to continue, then a message via email or text or via another social media account to the user informing them of this and requesting whether they wish to deactivate or cancel their card. Of course, a variety of combinations of the foregoing can be contemplated within the scope of the present disclosure.

In an embodiment, the device 12 is a POS device and once the user puts in their passcode or taps their bank card or taps their mobile device on the POS screen the POS captures an image of the user U. Indeed, the POS may not process the transaction until a proper image has been captured. The examples above described for the ATM can be applicable to the POS.

Indeed, for both the POS and the ATM devices 12, the image can be analyzed directly by the system controller 22 and/or the device controller 24 or the combination thereof to verify and confirm the identity of the real time user by comparting the captured image to the registered image as previously explained. It should also be noted that a POS controller may comprise the microprocessor in the physical POS and remote master server controlling the slave processor within the physical device. The foregoing is of course applicable to any user device 12 within the scope of the description.

The verification method and system herein is applicable to a variety of platforms including chatbots for example including and without limitation to the chatbots described in U.S. patent application Ser. No. 17/974,616, which is incorporated herein by reference in its entirety.

In an embodiment, the device 12 is comprise VR/AR/XR device such a glasses or oculus or headwear that include a camera for taking an image of the user's eyes or irises.

In embodiment, the device 12 comprises a car windshield computer device or other vehicle computer devices positioned on the dashboard, the windshield, the steering wheel and the like and providing a security measure for allowing input commands to be processed or not based on user identification.

In an embodiment, the user device 12 forms part of a home locking system and such the system 10 provides an additional security measure for inputting commands such as deactivating an alarm, unlocking a door, controlling a smart home etc. based on the identity verification steps provided herein.

In an embodiment, various platform interfaces 16 and devices 12 can be used in the present system 10 and method of computer implementable steps provided herein including and without limitation those described in U.S. patent application Ser. No. 18/127,327 which is incorporated herein by reference in its entirety.

The various features described herein can be combined in a variety of ways within the context of the present disclosure so as to provide still other embodiments. As such, the embodiments are not mutually exclusive. Elements of the embodiments and examples discussed can be combined within the context of the disclosure as those having skill in the art will readily appreciate. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

1. A computer implementable system for interface and/or device user identity verification comprising:
a user device comprising a device controller with an associated memory, a user interface, and a camera;
a system controller in communication with the user device and comprising a processor with an associated memory of processor executable code; and
a system accessible databank comprising a plurality of stored user profiles for each system user, each of the stored user profiles comprising a stored image of a respective one of the system users and one or more input command types associated with the stored image and requiring real time image identification,
wherein execution of the processor executable code provides the computer implementable system with performing computer-implementable steps comprising:
determining if a real time user command being inputted via the user interface corresponds to the one or more input command types requiring the real time image identification and identifying the stored image associated therewith thereby providing an identified stored image for user verification;
capturing a real time image of the real time user via the camera when the real time user command corresponds to the one or more input command types requiring the real time image identification thereby providing a capture image;
determining if the captured image corresponds or does not correspond to the identified stored image for user verification;
allowing the real time input command to the be executed if the captured image corresponds to the identified stored image and preventing the real time input command from being executed if the captured image does not correspond to the identified stored image.

2. A computer-implementable system according to claim 1, wherein the processor executable code is executed by the system controller and the computer-implementable steps are performed by the system controller.

3. A computer-implementable system according to claim 1, wherein the processor executable code is downloaded in:
the associated memory of the device controller to be executed by the device controller for performing the computer implementable steps or to be executed synergistically by a synergistic combination of the system controller and the device controller for the synergistic combination thereof to perform the computer implementable steps; and/or
one or more third party memories associated with one or more third party controllers in selective operative communication with the system controller and/or the device controller to be executed by the one or more third party controllers for performing the computer implementable steps or to be executed synergistically by:
a synergistic combination of the system controller and the one or more third party controllers for the synergistic combination thereof to perform the computer implementable steps;
a synergistic combination of the one or more third party controllers and the device controllers for the synergistic combination thereof to perform the computer implementable steps;
a synergistic combination of the system controller, the one or more third party controllers and the device controller for the synergistic combination thereof to perform the computer implementable steps.

4. A computer implementable system according to claim 3, wherein the one or more third party controllers are selected from the group consisting of a financial institution controller, a merchant controller, and a combination thereof.

5. A computer implementable system according to claim 3, wherein the step of determining if the captured image corresponds or does not correspond to the identified stored image for user verification is executed following a computer-generated request therefor by the system controller or by the one or more third party controllers of by the user device controller or by one any of the synergistic combinations thereof.

6. A computer implementable system according to claim 1, wherein the databank is stored in a computer memory selected from the group consisting of:
the associated memory of the system controller;
the associated memory of the user device;
one or more third party memories associated with one or more third party controllers in selective operative communication with the system controller and/or the device controller;
a synergistic combination of the associated memories of the system controller and the user device controller;
a synergistic combination of the associated memories of the system controller and the one or more third party controllers;
a synergistic combination of the associated memories of the user device and the one or more third party controllers; and
a synergistic combination of the associated memories of the system controller, the user device controller and the one or more third party controllers.

7. A computer implementable system according to claim 1, wherein the one or more input command types are selected from the group consisting of a transaction request, an access request, a communication request, a control request, a purchase request, a predetermined command request and any combination thereof.

8. A computer implementable system according to claim 7, wherein the access request comprises accessing data selected from the group consisting of a file, a platform, a website, a databank, a memory bank, and a combination thereof.

9. A computer implementable system according to claim 8, wherein accessing the file data comprises decrypting an encrypted file.

10. A computer implementable system according to claim 7, wherein the purchase request comprises user payment information input.

11. A computer implementable system according to claim 1, wherein the one or more input commands are time and/or location dependent for execution thereof based on time and/or location parameters stored in the user profile.

12. A computer implementable system according to claim 11, further comprising the computer implementable steps of:
controlling the camera to selectively capture images of an ambient environment thereby providing a plurality of captured environment images;
retrieving the captured environment images;
determining a geographic location of the device via accessing a geolocation tracking application.

13. A system according to claim 1, wherein the one or more input command types comprise one or more user identifier inputs stored in the user profile for user verification.

14. A computer implementable system according to claim 13, wherein the one or more identifier inputs are selected from the group consisting of: a passcode, a voice recognition input, a fingerprint recognition input, a touchscreen slide pattern input, user biometric data input, payment information, a device identification input, and a combination thereof.

15. A computer implementable system according to claim 14, wherein the device identification input is selected from the group consisting of a location identifier of the user device communicated thereby to the system, a subscriber identity module (SIM) identifier of the user device communicated thereby to the system, an internet protocol address (IPS) identifier of the user device communicated thereby to the system, an identifier code of the user device communicated thereby to the system and a combination thereof.

18-21: (canceled)

22. A computer implementable system according to claim 1, wherein the stored image is captured via the camera following a user input command therefor via the user interface and prompted by a system request therefor via the user interface.

23. A computer implementable system according to claim 1, wherein the stored image is captured via the camera following a given predetermined type of a real time user input command.

24. A computer implementable system according to claim 1, wherein when the execution of the real time input command is prevented from being executed, the system further comprises the computer implementable step of transmitting a signal indicative thereof.

25. A computer implementable system according to claim 24, wherein the signal indicative of the prevented real time input command comprises a visual and/or audial and/or vibrational message transmitted via the user device.

26. A computer implementable system according to claim 24, wherein the signal indicative of the prevented real time input command blocks access to one or more online accounts associated with the user profile.

27. A computer implementable method for interface and/or device user identity verification comprising:
providing a databank comprising a plurality of stored user profiles for each system user, each of the stored user profiles comprising a stored image of a respective one of the system users and one or more input command types associated with the stored image and requiring real time image identification;
determining if a real time user command being inputted via a user interface associated with a user device corresponds to the one or more input command types requiring the real time image identification and identifying the stored image associated therewith thereby providing an identified stored image for user verification;
capturing a real time image of the real time user via a camera associated with the user device when the real time user command corresponds to the one or more input command types requiring the real time image identification thereby providing a capture image;
determining if the captured image corresponds or does not correspond to the identified stored image for user verification; and
allowing the real time input command to the be executed if the captured image corresponds to the identified stored image and preventing the real time input command from being executed if the captured image does not correspond to the identified stored image.
